(19) United States
(12) Patent Application Publication
(10) Pub. No.: US 2002/0054711 A1
(43) Pub. Date: May 9, 2002

(54) Method for transmitting image data of a scanner

(75) Inventors: Bar-Chung Hwang, Taoyuan (TW); Shi-Tron Lin, Taipei (TW); Chien-Chi Yang, Hsinchu (TW)

Correspondence Address: Richard P. Berg, Esq., c/o LADAS & PARRY, Suite 2100, 5870 Wilshire Boulevard, Los Angeles, CA, 90036-5679, US

(73) Assignee: Winbond Electronics Corp.

(21) Appl. No.: 10/008,863

(22) Filed: Nov. 7, 2001

(30) Foreign Application Priority Data
Nov. 8, 2000 (TW) 89123551

(51) Int. Cl. G06K 9/36

(52) U.S. Cl. 382/240

(57) ABSTRACT

A method for transmitting image data of a scanner is disclosed, in which the transmitted image data is divided into two portions, i.e., the uncompressed portion of low-resolution data and the compressed portion of the data difference. The compressed portion of the data difference can be decompressed and then combined with the uncompressed portion of low-resolution data to obtain an image in a high resolution. Thus the scanned image in a low resolution, a medium resolution or a high resolution can be optionally displayed. While displaying the scanned image, the low-resolution image can be first displayed. If the low-resolution image is acceptable, the compressed-data difference values do not need to be processed and can be directly disregarded. Therefore, the data to be transmitted and processed during the scanning process can be reduced to accelerate the scanning and displaying speed. On she contrary, if the low-resolution image is not acceptable, the compressed-data difference values can be further decompressed and then combined with the low-resolution image data to obtain a high-resolution image.

### BACKGROUND OF THE INVENTION

1. Field of the Invention

The present invention relates to a method for transmitting image data of a scanner.

2. Description of the Related Art

A conventional scanner normally uses 1 to 3 line buffers to temporarily store the image data being scanned. Referring to FIG. 1, which illustrates the case of using two line buffers to store image data. In order to reduce the cost, the memory space is normally limited to a small amount for the scanners on the market. Therefore, the memory of a conventional scanner cannot store a whole page of scanned image. On the other hand, as shown in FIG. 2, a conventional scanner does not compress each scanning line of image data in order to directly display the scanned image. Accordingly, a large amount of data has to be transmitted. In other words, it needs a lot of time to transmit an image.

The data transmitting speed is inversely proportional to the image quality for a prior-art scanner. For example, the image quality is good if the resolution is 600 dpi. However, it takes a longer time to transmit such an image since a larger amount of data has to be transmitted. On he contrary, the image quality is poor if the resolution is 150 dpi. However, it takes a shorter time to transmit such an image since only a smaller amount of data has to be transmitted. The resolution has to be determined for a scanner before scanning an image. If an image is scanned in a low resolution, whether or not the quality of the scanned image is acceptable can be determined only after finishing the data transmission of the scanned image. It takes time to wait for the result. Moreover, if the image quality is not acceptable, the image has to be scanned again with a high resolution. The above problem can be avoided if every image is scanned only in high resolution. However, a lot of time is needed to transmit the image data, but not every image needs to be scanned at a high resolution.

### SUMMARY OF THE INVENTION

Accordingly, in order to improve the drawbacks of the prior arts, an object of the present invention is to provide a method for transmitting image data of a scanner, which can select the resolution of the scanned image during the data transmission.

According to this invention, the data transmitted from a scanner includes an uncompressed portion of low-resolution data and a compressed portion of the data difference. The uncompressed portion of low-resolution data has a format as the image data of a conventional scanner, which can be directly displayed. The compressed portion of the data difference can be combined with the uncompressed portion of low-resolution data to display an image at a high resolution at the receiving end of the image data.

In this invention, a part of the data of the scanned image can be first transmitted to display the image in a low resolution, and the other data of the scanned image is then transmitted to display the image at a high resolution if the quality of the low-resolution image is not acceptable. Therefore, the time needed so transmit the data of a scanned image can be effectively reduced.

The method of this invention is suitable to apply to a scanner having a limited memory since the overhead of high-resolution image data does not need to be transmitted and the scanned image in a low resolution, a medium resolution or a high resolution can be optionally displayed.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram illustrating that a conventional scanner stores the image data in two line buffers;

FIG. 2 is a diagram illustrating that a conventional scanner transmits image data;

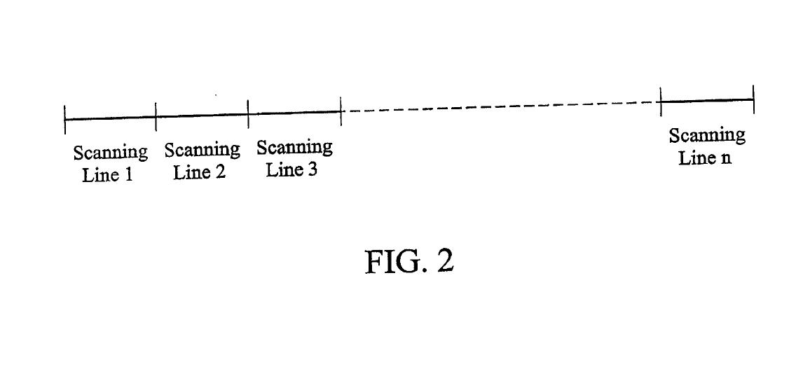

FIG. 3 is a diagram illustrating that a scanner transmits image data according to one embodiment of this invention;

FIG. 4 is a diagram illustrating that a scanner transmits image data according to another embodiment of this invention;

FIG. 5 is a diagram illustrating that a scanner transmits image data according to another embodiment of this invention;

FIG. 6 is a diagram illustrating that a scanner transmits image data according to another embodiment of this invention;

FIG. 7 is a block diagram illustrating an embodiment of the apparatus embodying the method of this invention; and

FIG. 8 is a block diagram illustrating another embodiment of the apparatus embodying the method of this invention.

### DETAILED DESCRIPTION OF THE PREFERRED EMBODIMENT

According to this invention, the transmitted data is divided into two portions, i.e., the uncompressed portion of low-resolution data and the compressed portion of data difference. The compressed portion of the data difference can be decompressed and then combined with the uncompressed portion of low-resolution data to obtain an image at a high resolution. Various embodiments of this invention are given below.

### EXAMPLE 1

In this embodiment, the low-resolution image data is transmitted in a sample unit. A sample can be one or the average of the plural pixel data, which are retrieved at one time. The data difference can be the difference of the pixel data served as the low-resolution image data and the other pixel data or the difference of the average data of the plural pixels and each data of the plural pixels.

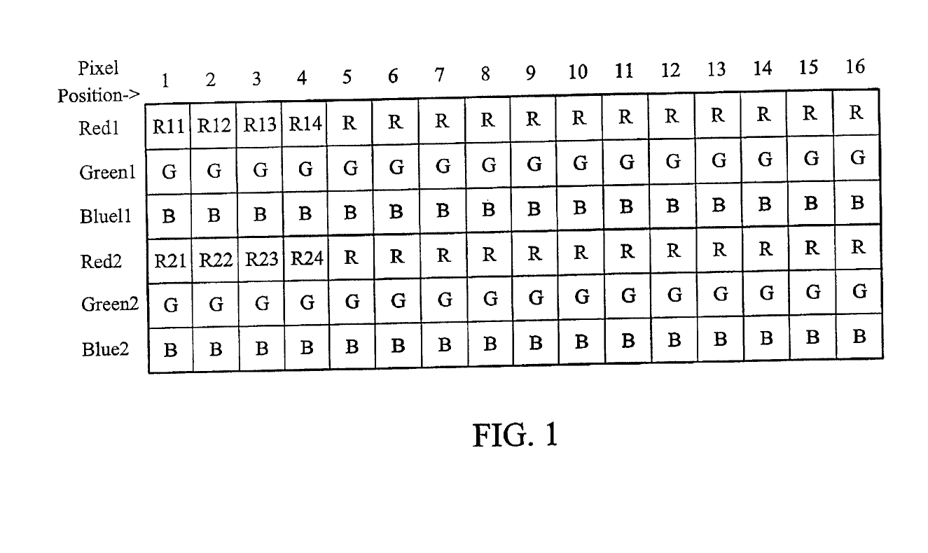

Referring to FIG. 1, she two line buffers of image data are taken as an example, and only the pixel data of red color is described here. The processing process of the pixel data of green color and blue color is the same as that of red color. Therefore, the description related to the pixel data of green color and blue color is omitted. According to this invention, the pixel data of the first row and the second row of the first line buffer and the second buffer are respectively retrieved in sequence, i.e., R11, R12, R21 and R22. Thereafter, the data of a pixel at a predetermined position such as the upper-left is selected as the low-resolution image data, that is R11. Alternatively, the average Ravg_11 of the pixel data R11, R12, R21 and R22 is used as the low-resolution image data. The data difference can be the difference of R12, R21, R22 and R11, that is, (R12-R11), (R21-R11) and (R22-R11) . Alternatively, the data difference can be the difference of the average Ravg_11 and the pixel data R11, R12, R21 and R22, that is, (R11- Ravg_11), (R12-Ravg_11), (R21-Ravg_11) and (R22- Ravg_11).

The pixel data R13, R14, R23 and R24 are retrieved as soon as the low-resolution image data and the compressed data difference are respectively transmitted to the receiving end, such as a PC. Then the pixel data is processed as described above.

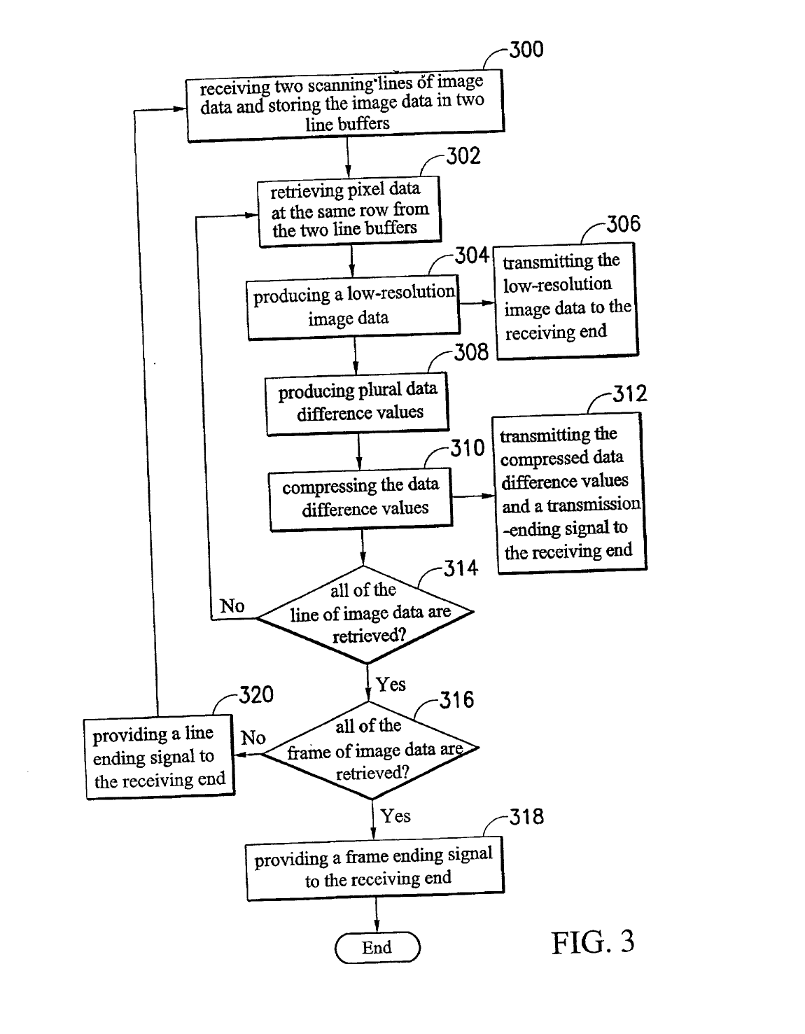

FIG. 3 illustrates the flow chart of this embodiment, which includes the steps of: (i) step 300, receiving two scanning lines of image data, and storing the two scanning lines of image data in two line buffers; (ii) step 302, retrieving pixel data at the same row from the two line buffers; (iii) step 304 using the pixel data to produce a low-resolution image data; (iv) step 306, transmitting the low-resolution image data to the receiving end; (v) step 308, using the pixel data to produce plural data difference values, which can combine with the low-resolution image data to obtain a high-resolution image; (vi) step 310, compressing the data difference values; (vii) step 312, transmitting the compressed-data difference values and a transmission ending signal to the receiving end; (viii) step 314, determining whether all of the lines of image data are retrieved, going to the next step if yes, otherwise going to step (ii); (ix) step 316, determining whether all of the frames of image data are retrieved, going to the next step if yes, otherwise going to step (xi); (x) step 318, providing a frame-ending signal to the receiving end, and going to the end; (xi) step 320, Providing a line-ending signal to the receiving end and going back to step (i).

EMBODIMENT 2

The process of producing the low-resolution image data and the compressed data difference value is the same in this embodiment as that of the previous embodiment. However, the data transmission of this embodiment is different from that of the first embodiment. After producing a low-resolution image data and compressed data difference values, they are temporarily stored in the memory of the scanner. The low-resolution image data and the compressed-data difference values are not transmitted to the receiving end until all of the line buffers of data are processed.

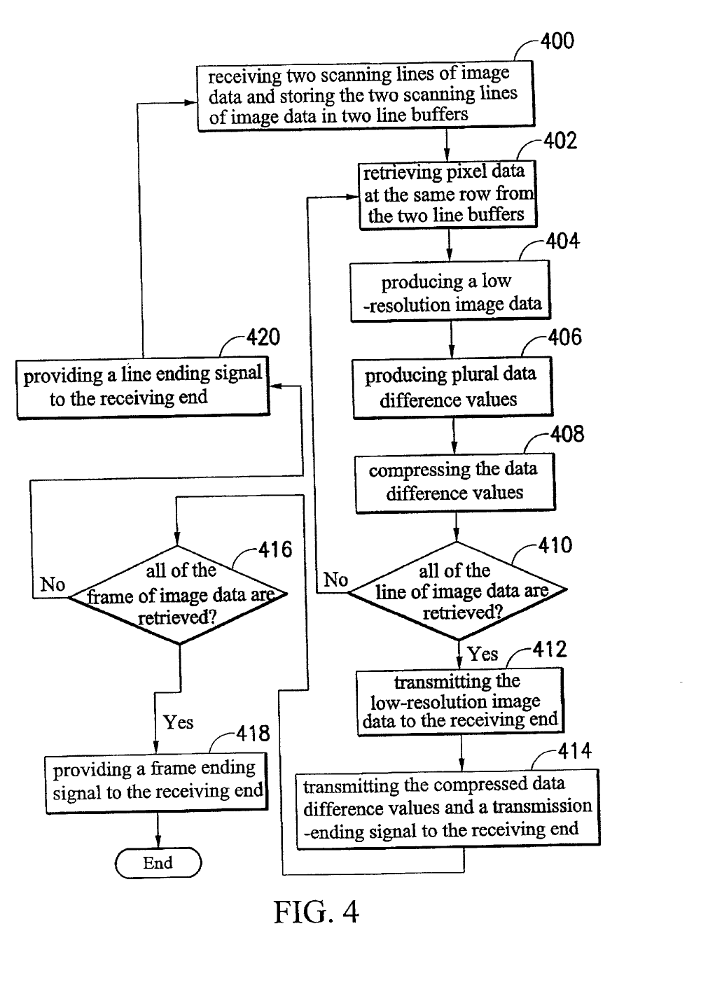

FIG. 4 illustrates the flow chart of this embodiment, which includes the steps of: (i) step 400, receiving two scanned lines of image data, and storing the two scanning lines of image data in two line buffers; (ii) step 402, retrieving pixel data at the same row from the two line buffers; (iii) step 404, using the pixel data to produce a low-resolution image data; (iv) step 406, using the pixel data to produce plural data difference values, which can combine with the low-resolution image data to obtain a high-resolution image; (v) step 408, compressing the data difference values; (vi) step 410, determining whether all of the lines of image data are retrieved, going to the next step if yes, otherwise going to step (ii); (vii) step 412, transmitting the low-resolution image data to the receiving end; (viii) step 414, transmitting the compressed-data difference values and a transmission ending signal to the receiving end; (ix) step 416, determining whether all of the frames of image data are retrieved, going to the next step if yes, otherwise going to step (xi); (x) step 418, providing a frame-ending signal to the receiving end, and going to the end; (xi) step 420, providing a line-ending signal to the receiving end and going back to step (i).

EMBODIMENT 3

The process of producing the low-resolution image data and the compressed data difference value is the same in this embodiment as that of the previous embodiment. However, the pixel data or the average value served as the low-resolution image data are temporarily stored in the memory of the scanner while processing the line buffer of image data. The low-resolution image data is transmitted to the receiving end as soon as the processing of the line buffers of data is accomplished. The compressed-data difference values are temporarily stored in the memory of the scanner while processing the line buffers of image data and are transmitted to the receiving end after finishing processing the whole frame of image data.

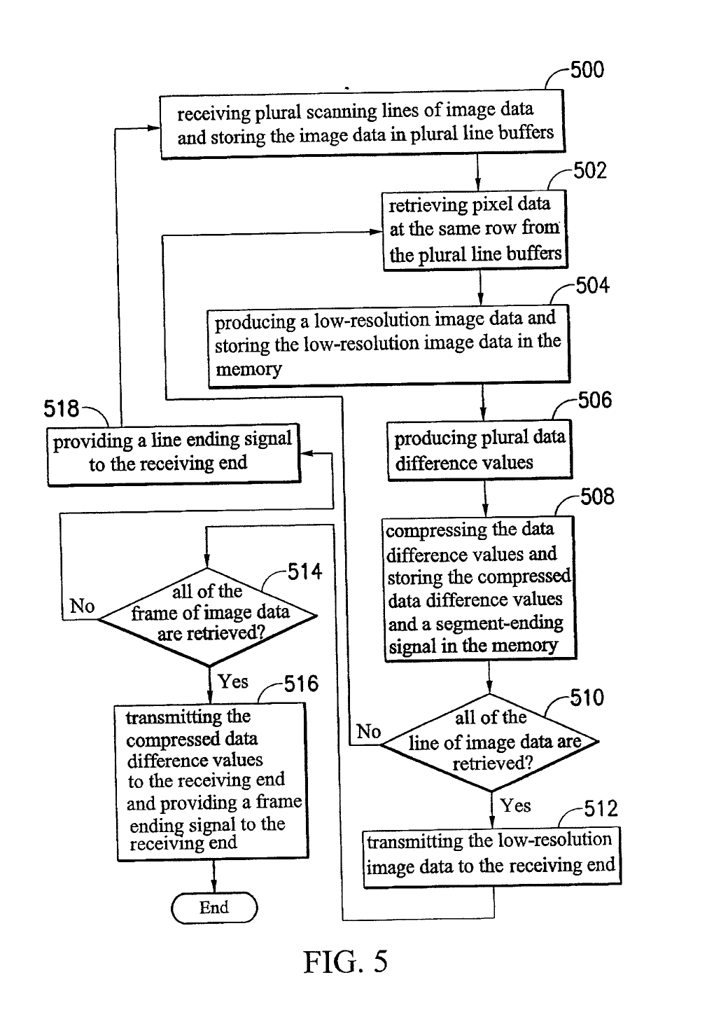

FIG. 5 illustrates the flow chart of this embodiment, which includes the steps of: (i) step 500, receiving plural scanning lines of image data, and storing the scanning lines of image data in plural line buffers; (ii) step 502, retrieving pixel data at the same row from the plural line buffers; (iii) step 504, using the pixel data to produce a low-resolution image data and storing the low-resolution image data in the memory of the scanner; (iv) step 506, using the pixel data to produce plural data difference values, which can combine with the low-resolution image data to obtain a high-resolution image; (v) step 508, compressing the data difference values and storing the compressed-data difference values and a segment-ending signal in the memory of the scanner; (vi) step 510, determining whether all of she lines of image data are retrieved, going to the next step if yes, otherwise going to step (ii); (vii) step 512, transmitting the low-resolution image data to the receiving end; (viii) step 514, determining whether all of the frames of image data are retrieved, going to the next step if yes, otherwise going to step (x); (ix) step 516, transmitting the compressed-data difference values to the receiving end and providing a frame-ending signal to the receiving end, and going to the end; (x) step 518, providing a line-ending signal to the receiving end and going back to step (i).

EMBODIMENT 4

The process of producing the low-resolution image data and the compressed data difference value is the same as that of the previous embodiment. The low-resolution image data is temporarily stored in the memory of the scanner while processing the frame of image data. After finishing processing the whole frame of image data, the low-resolution image data is transmitted to the receiving end. The compressed-data difference values are also stored in the memory of the scanner while processing the frame of image data and are not transmitted to the receiving end until the low-resolution image data is transmitted.

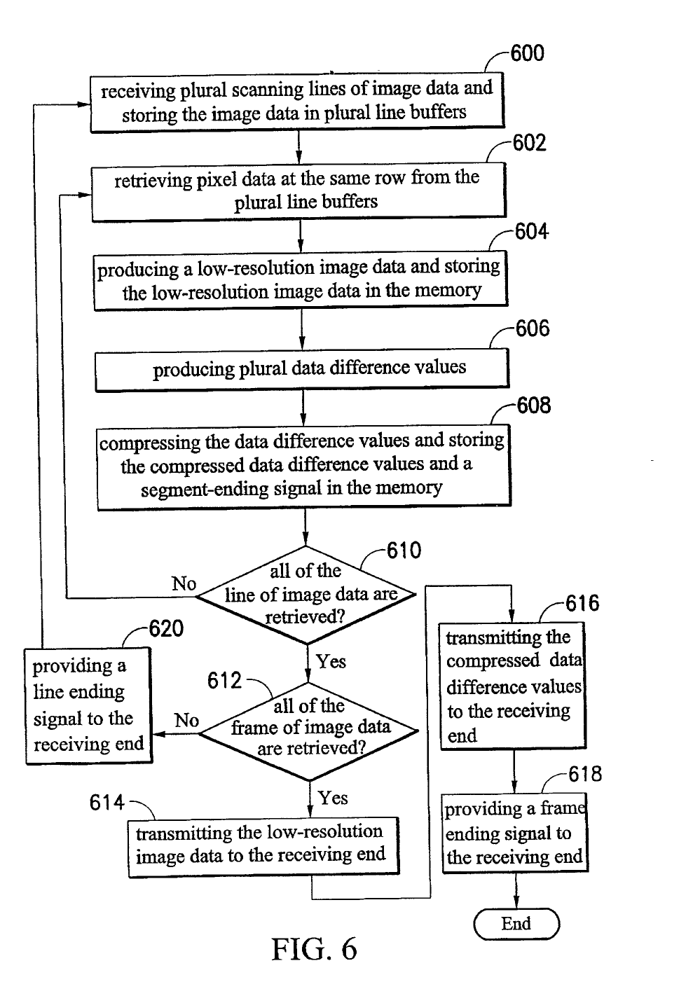

FIG. 6 illustrates the flow chart of this embodiment, which includes the steps of: (i) step 600, receiving plural scanning lines of image data, and storing the scanning lines of image data in plural line buffers; (ii) step 602, retrieving pixel data at the same row from the plural line buffers; (iii) step 604, using the pixel data to produce a low-resolution image data and storing the low-resolution image data in the memory of the scanner; (iv) step 606, using the pixel data to produce plural data difference values, which can combine with the low-resolution image data to obtain a high-resolution image; (v) step 608, compressing the data difference values and storing the compressed-data difference values and a segment-ending signal in the memory of the scanner; (vi) step 610, determining whether all of the lines of image data are retrieved, going to the next step if yes, otherwise going to step (ii); (vii) step 612, determining whether all of the frames of image data are retrieved, going to the next step if yes, otherwise going to step (xi); (viii) step 614, transmitting the low-resolution image data to the receiving end; (ix) step 616, transmitting the compressed-data difference values to the receiving end; (x) step 618, providing a frame-ending signal to the receiving end and going to the end; (xi) step 620, providing a line-ending signal to the receiving end and going back to step (i).

In the above embodiments, the compression of the data difference values can be the Huffman compression technique.

The segment-ending signal indicates the end of a segment. The data transmitting sequence includes a plurality of segments, in which each segment contains low-resolution image data or compressed data difference values.

The various methods disclosed in the above embodiments can be used accompanying various scanners. For example, the process of embodiment 3 or 4 can be used if the scanner has a larger memory. Since the compressed-data difference values are transmitted after finishing processing the whole frame of image data, it is not necessary to transmit the compressed-data difference values if the low-resolution image is acceptable. Thus the amount of he transmitted data is significantly reduced.

As described above, the scanned image is divided into two parts, i.e., the uncompressed low-resolution image data, which can be directly displayed, and the compressed data difference values. While displaying the scanned image, the low-resolution image can be first displayed. If the low-resolution image is acceptable, the compressed-data difference values do not need to be processed and can be directly disregarded. Therefore, the data to be transmitted and processed during the scanning process can be reduced to accelerate the scanning and displaying speed. On the contrary, if the low-resolution image is not acceptable, the compressed-data difference values can be further decompressed and then combined with the low-resolution image data to obtain a high-resolution image. According to this invention, the amount of the transmitted data is relatively small even displaying a high-resolution image since the data difference values have been compressed.

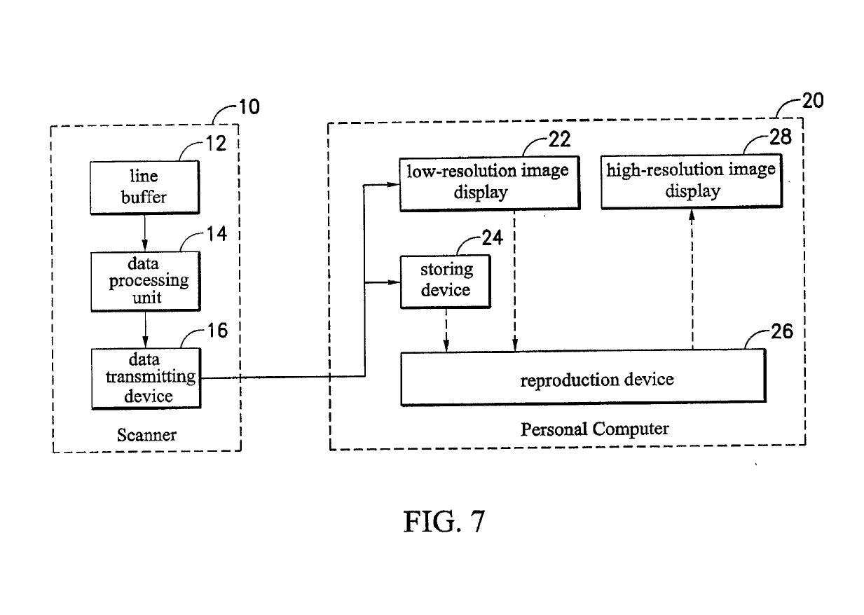

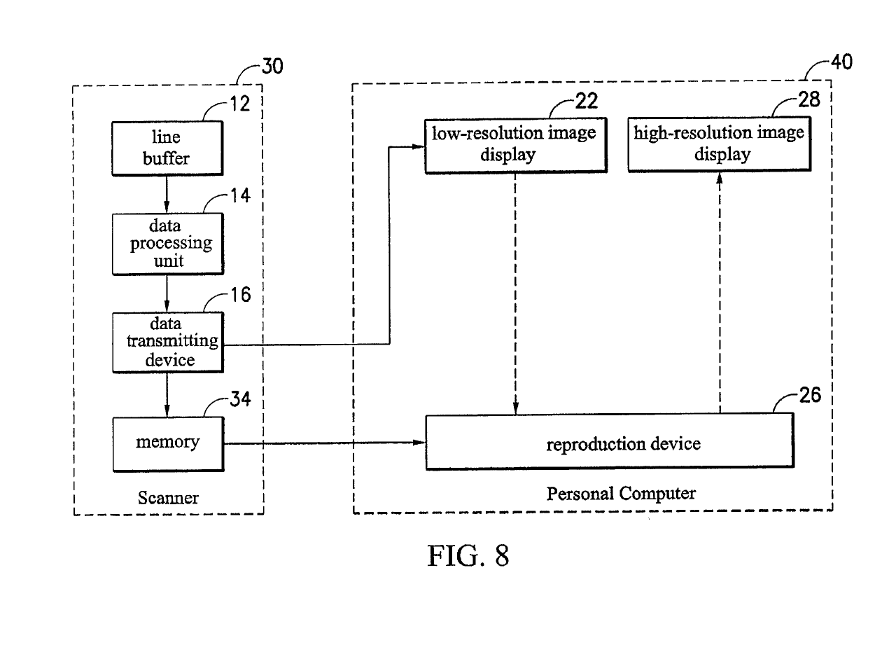

FIGS. 7 and 8 respectively illustrate the apparatus embodying the method of this invention. In the drawings, the solid line represents the signal transmission of displaying a low-resolution image, and the dotted line represents the signal transmission of displaying a high-resolution image.

Referring to FIG. 7, the scanning system includes a scanner 10 and a personal computer 20. The scanner 10 includes a line buffer 12, a data processing unit 14 and a data transmitting device 16. The personal computer 20 includes a low-resolution image display device 22, a storing device 24, a reproduction device 26 and a high-resolution image display device 28.

The line buffer 12 is used to store the scanned image data. The number of the line buffers is normally from 1 to 3. Two line buffers are used in the embodiments of this invention.

The data processing unit 14 is used to retrieve image data from the line buffer 12, to divide the image data into the low-resolution image data and the data difference values and a compress the data difference values.

The data transmitting device 16 is used to respectively transmit the uncompressed low-resolution image data and the compressed-data difference values to the personal computer 20.

The low-resolution image display device 22 is used to receive the uncompressed low-resolution image data and directly display the low-resolution image.

The storing device 24 is used to temporarily store the compressed data difference values.

The reproduction device 26 receives the uncompressed low-resolution image data from the low-resolution image display device 22 and the compressed-data difference values from the storing device 24, respectively. Then the reproduction device 26 compresses the compressed-data difference values and reproduces a high-resolution image by combining the low-resolution image data and the decompressed data difference values. The high-resolution image is transmitted to and displayed by the high-resolution image display device 28.

Referring to FIG. 8, according to another embodiment, the scanning system includes a scanner 30 and a personal computer 40. The scanner 30 includes a line buffer 12, a data processing unit 14, a data transmitting device 16 and a memory 34. The personal computer 40 includes a low-resolution image display device 22, a reproduction device 26 and a high-resolution image display device 28.

The same reference numeral indicates the same elements in the above embodiments. Therefore the relevant description is omitted.

Different from the structure of FIG. 7, the scanner in FIG. 8 has a memory 34 in the structure of FIG. 8, which can be used to store the compressed data difference values. Thus the compressed-data difference values are directly transmitted to the reproduction device 26 of the personal computer 40 only when it has to display a high-resolution image. The compressed-data difference values can be neglected to avoid unnecessary data transmission if it is not necessary to display a high-resolution image.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for transmitting image data of a scanner including the steps of:
receiving plural scanning lines of image data, and storing the scanning lines of image data in plural line buffers;
retrieving pixel data at the same row from the plural line buffers;
using the pixel data to produce a low-resolution image data and transmitting the low-resolution image data to a receiving end;
using the pixel data to produce plural data difference values; and
compressing the data difference values and transmitting the compressed-data difference values.

2. A method for transmitting image data of a scanner including the steps of:
(i) receiving plural scanning lines of image data, and storing the scanning lines of image data in plural line buffers;
(ii) retrieving pixel data at the sane row from the plural line buffers;
(iii) using the pixel data to produce a low-resolution image;
(iv) using the pixel data to produce plural data difference values, which can combine with the low-resolution image data to produce a high-resolution image;
(v) compressing the data difference values;
(vi) determining whether all of the scanned lines of image data are retrieved, going to next step if yes, otherwise going to step (ii);
(vii) transmitting the low-resolution image data to a receiving end;
(viii) transmitting the compressed-data difference values to the receiving end;
(ix) determining whether all of the frame of image data is retrieved, going to next step if yes, otherwise going to step (xi);
(x) providing a frame-ending signal to the receiving end; and
(xi) providing a line-ending signal to the receiving end and going back to step (i).

3. The method as claimed in claim 1 wherein the low-resolution image data includes a pixel datum of the retrieved pixel data.

4. The method as claimed in claim 1 wherein the low-resolution image data includes the average of the retrieved pixel data.

5. The method as claimed in claim 1 wherein the number of the scanned lines is 2.

6. The method as claimed in claim 1, further including the step of:
determining whether all of the frames of image data are retrieved, providing a frame-ending signal to the receiving end if yes.

7. The method as claimed in claim 2 wherein, in step (viii), a transmission-ending signal is transmitted to the receiving end while transmitting the compressed-data difference values to the receiving end.

8. The method as claimed in claim 2 wherein the low-resolution image data includes a pixel datum of the pixel data retrieved in step (ii).

9. The method as claimed in claim 2 wherein the low-resolution image data includes the average of the pixel data retrieved in step (ii).

10. The method as claimed in claim 2 wherein the number of the scanned lines is 2.

11. The method as claimed in claim 3 wherein the data difference values are taken from the derived difference of the pixel datum served as the low-resolution image data and the pixel data except for the pixel datum.

12. The method as claimed in claim 4 wherein the data difference values are taken from the difference of the pixel data and the average value of the pixel data.

13. The method as claimed in claim 8 wherein the data difference values are taken from the difference of the pixel datum served as the low-resolution image data and the pixel data except for the pixel datum.

14. The method as claimed in claim 9 wherein the data difference values are taken from the difference of the pixel data and the average value of the pixel data.

15. A method for transmitting image data of a scanner including the steps of:
(i) receiving plural scanning lines of image data, and storing the scanning lines of image data in plural line buffers;
(ii) retrieving pixel data at the same row from the plural line buffers;
(iii) using the pixel data to produce a low-resolution image data and storing the low-resolution image data in a buffer of the scanner;
(iv) using the pixel data to produce plural data difference values, which can combine with the low-resolution image data to produce a high-resolution image;
(v) compressing the data difference values and storing the compressed-data difference values in the memory of the scanner;
(vi) determining whether all of the scanned lines of image data are retrieved, going to next step if yes, otherwise going to step (ii);
(vii) transmitting the low-resolution image data to a receiving end;
(viii) determining whether all of the frame of image data is retrieved, transmitting the compressed-data difference values and a frame-ending signal to the receiving end if yes, otherwise providing a line-ending signal to the receiving end and going back to step (i).

16. A method for transmitting image data of a scanner including the steps of:
(i) receiving plural scanned lines of image data, and storing the scanning lines of image data in plural line buffers;
(ii) retrieving pixel data at the same row from the plural line buffers;
(iii) using the pixel data to produce a low-resolution image data and storing the low-resolution image data in the memory of the scanner;
(iv) using the pixel data to produce plural data difference values, which can combine with the low-resolution image data to produce a high-resolution image;
(v) compressing the data difference values, and storing the compressed-data difference values and a segment-ending signal in the memory of the scanner;
(vi) determining whether all of the scanned lines of image data are retrieved, going to next step if yes, otherwise going to step (ii);
(vii) determining whether all of the frame of image data is retrieved, going to the next step if yes, otherwise going to step (x);
(viii) transmitting the low-resolution image data to a receiving end;
(ix) transmitting the compressed-data difference values and a frame-ending signal to the receiving end and going to the end;
(x) providing a line-ending signal to the receiving end and going back to step (i).

17. The method as claimed in claim 15 wherein the low-resolution image data includes a pixel datum of the pixel data retrieved in step (ii).

18. The method as claimed in claim 15 wherein the low-resolution image data includes the average of the pixel data retrieved in step (ii).

19. The method as claimed in claim 15 wherein the number of the scanning lines is 2.

20. The method as claimed in claim 15 wherein, in step (viii), a transmission-ending signal is transmitted to the receiving end while transmitting the compressed-data difference values To the receiving end.

21. The method as claimed in claim 16 wherein, in step (ix), a transmission-ending signal is transmitted to the receiving end while transmitting the compressed-data difference values to the receiving end.

22. The method as claimed in claim 16 wherein the low-resolution image data includes a pixel datum of the pixel data retrieved in step (ii).

23. The method as claimed in claim 16 wherein the low-resolution image data includes the average of the pixel data retrieved in step (ii).

24. The method as claimed in claim 6 wherein the number of the scanned lines is 2.

25. The method as claimed in claim 17 wherein the data difference values are taken from the difference of the pixel datum served as the low-resolution image data and the pixel data except for the pixel datum.

26. The method as claimed in claim 18 wherein the data difference values are the difference of the pixel data and the average value of the pixel data.

27. The method as claimed in claim 22 wherein the data difference values are the difference of the pixel datum served as the low-resolution image data and the pixel data except the pixel datum.

28. The method as claimed in claim 23 wherein the data difference values are the difference of the pixel data and the average value of the pixel data.
